(19) United States
(12) Patent Application Publication
(10) Pub. No.: US 2024/0088523 A1
(43) Pub. Date: Mar. 14, 2024

(54) TERMINAL HOLDING STRUCTURE AND BUSBAR MODULE

(71) Applicant: YAZAKI CORPORATION, Tokyo (JP)

(72) Inventors: Hiroyuki Kato, Kakegawa-shi (JP); Yoshikazu Ezuka, Kakegawa-shi (JP); Ryota Kataoka, Kakegawa-shi (JP)

(21) Appl. No.: 18/513,286

(22) Filed: Nov. 17, 2023

Related U.S. Application Data
(63) Continuation of application No. PCT/JP2022/045501, filed on Dec. 9, 2022.

(30) Foreign Application Priority Data
Dec. 10, 2021 (JP) 2021-200850

(51) Int. Cl. H01M 50/503; H01M 50/507

(52) U.S. Cl. CPC H01M 50/503; H01M 50/507

(57) ABSTRACT

A terminal holding structure includes a detection terminal having a through hole penetrating in an attaching direction to an object to be conductively connected, a resin case including an insertion portion to be inserted into the through hole and configured to hold the detection terminal, and a restricting member configured to restrict movement of the detection terminal in the attaching direction.

### CROSS-REFERENCE TO RELATED APPLICATIONS

This is a continuation of International Application No. PCT/JP2022/045501 filed on Dec. 9, 2022, and claims priority from Japanese Patent Application No. 2021-200850 filed on Dec. 10, 2021, the entire content of which is incorporated herein by reference.

### TECHNICAL FIELD

The present invention relates to a terminal holding structure and a busbar module.

### BACKGROUND ART

In the related art, a busbar module is used for a purpose of, for example, supplying power to various electrical components from an assembled battery in which a plurality of battery cells are stacked. The assembled battery is also referred to as a cell module. For example, a related busbar module includes a plurality of busbars that are stacked and connect a positive electrode and a negative electrode between adjacent battery cells, a detection terminal that is connected to each of the plurality of busbars and monitors a potential state of each battery cell, and a resin case that accommodates the busbar and the detection terminal (see, for example, Patent Literature 1).

### CITATION LIST

### Patent Literature

Patent Literature 1: JP2019-021593A

### SUMMARY OF INVENTION

In general, in the assembled battery described above, a variation may occur in a position of an electrode of the battery cell due to a manufacturing tolerance of the battery cell and an assembly tolerance generated when stacking the battery cell. Further, the battery cell expands and contracts due to an operation heat associated with charging and discharging, a temperature of an external environment, and the like. With this expansion and contraction, the position of the electrode of the battery cell is displaced. That is, a certain degree of variation may inevitably occur at the position of the electrode of the battery cell. Therefore, in the busbar module of the type described above, in order to cope with such a variation in the position of the electrode of the battery cell, a locking claw for fixing the busbar provided in the resin case may be arranged with a predetermined gap with the busbar. By allowing the positional deviation of the busbar by this gap, the variation in the position of the electrode of the battery cell is absorbed.

When the gap between the locking claw and the busbar is increased in order to increase an absorption amount of the variation in the position of the electrode of the battery cell, there is a concern that the busbar is detached from the locking claw and detached from the resin case when the busbar is inclined with respect to the locking claw. On the other hand, if an engagement margin of the locking claw to the busbar is increased in order to prevent the detachment of the busbar, there is a concern that it becomes difficult to accommodate the busbar in the resin case. In this way, it is generally difficult to increase the absorption amount of the variation in the position of the electrode of the battery cell while maintaining original functions of the resin case of the busbar module and the locking claw.

Further, as can be understood from the above description, not only the busbar module, it is also generally contradictory to each other to appropriately hold a terminal attached to an object, which is to be conductively connected, to a case and to absorb a variation in a shape and a position of the object.

One of objects of the present invention is to provide a terminal holding structure capable of achieving both appropriately holding a terminal attached to an object, which is to be conductively connected, to a case and absorbing a variation in a shape and a position of the object, and a busbar module using the holding structure.

According to one aspect of the present invention, a terminal holding structure includes a terminal having a through hole penetrating in an attaching direction to an object to be conductively connected, a case including an insertion portion to be inserted into the through hole and configured to hold the terminal, and a restricting member configured to restrict movement of the terminal in the attaching direction. The terminal includes an extending portion extending from a hole edge of the through hole and curved along the attaching direction.

Further, according to another aspect of the present invention, a busbar module includes a terminal including a busbar to be conductively connected to a battery, and a through hole penetrating in an attaching direction to the battery, a case including an insertion portion to be inserted into the through hole and configured to hold the terminal in a manner that the busbar is arranged at a position corresponding to the battery, and a restricting member configured to restrict movement of the terminal in the attaching direction. The terminal includes an extending portion extending from a hole edge of the through hole and curved along the attaching direction.

### BRIEF DESCRIPTION OF DRAWINGS

FIG. 1 is a top view illustrating a power supply device including a busbar module according to an embodiment of the present invention;

FIG. 2 is an enlarged view of a portion A in FIG. 1;

FIG. 3 is a diagram corresponding to FIG. 2 in which a cover is opened;

FIG. 4 is a perspective view of a terminal illustrated in FIG. 1;

FIG. 5 is a cross-sectional view taken along a line B-B in FIG. 2;

FIG. 6 is an enlarged view of a portion C in FIG. 5;

FIG. 7 is a cross-sectional view taken along a line D-D in FIG. 6;

FIG. 8 is a diagram corresponding to FIG. 7 in which a first modification is illustrated;

FIG. 9 is a diagram corresponding to FIG. 6 in which a second modification is illustrated, and

FIG. 10 is a perspective view of a terminal according to a third modification.

### DESCRIPTION OF EMBODIMENTS

### Embodiment

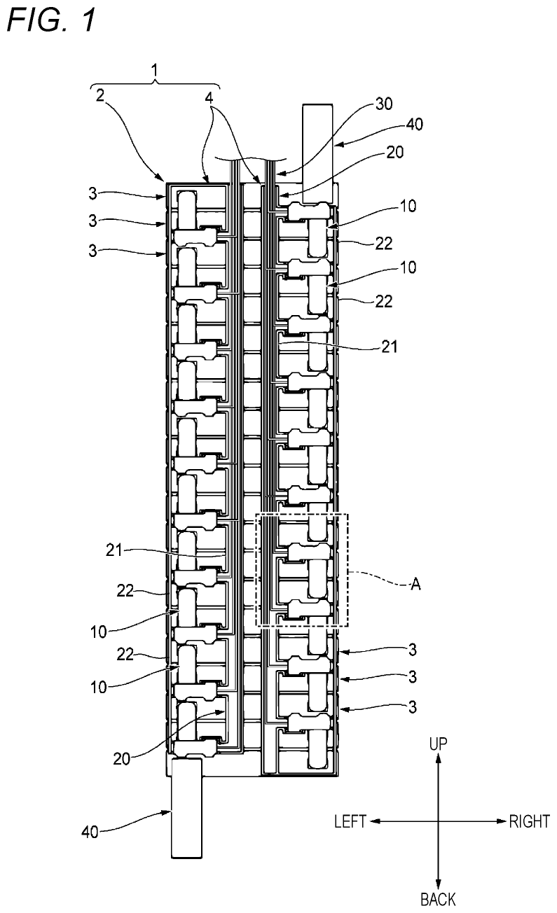

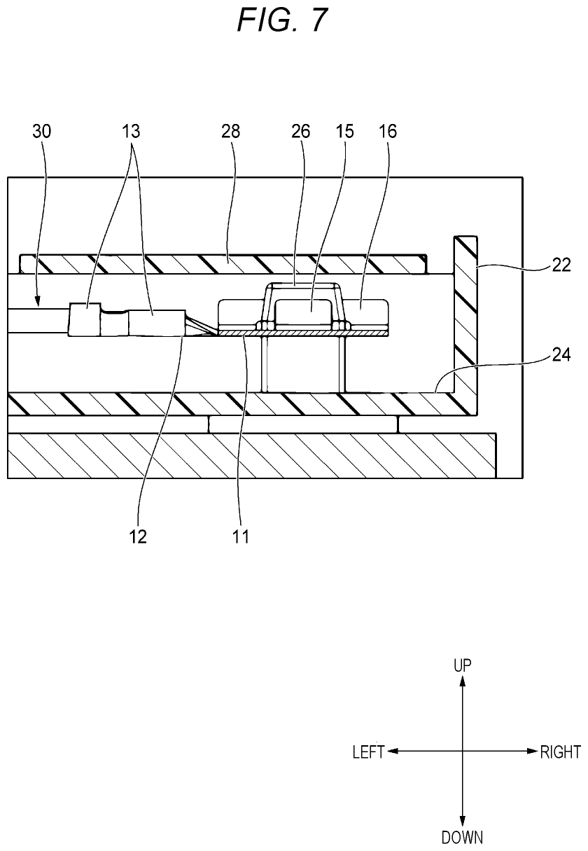

Hereinafter, a battery module 1 including busbar modules 4 according to an embodiment of the present invention will be described with reference to the drawings. Hereinafter, for convenience of description, as illustrated in FIGS. 1 to 10, a “front-rear direction”, a “left-right direction”, and an “up-down direction” are defined. The “front-rear direction”, the “left-right direction”, and the “up-down direction” are orthogonal to each other.

As illustrated in FIG. 1, the battery module 1 is formed by attaching the pair of left and right busbar modules 4 each extending in the front-rear direction to an upper face of a rectangular parallelepiped assembled battery 2 that is long in the front-rear direction. The assembled battery 2 is formed by stacking a plurality of rectangular parallelepiped battery cells 3 that are short in the front-rear direction in the front-rear direction. The battery module 1 is mounted, for example, in an electric automatic vehicle that travels using an electric motor, or a hybrid automatic vehicle that travels by using an engine and an electric motor in combination, and is used for a purpose of supplying power to an electric motor or the like.

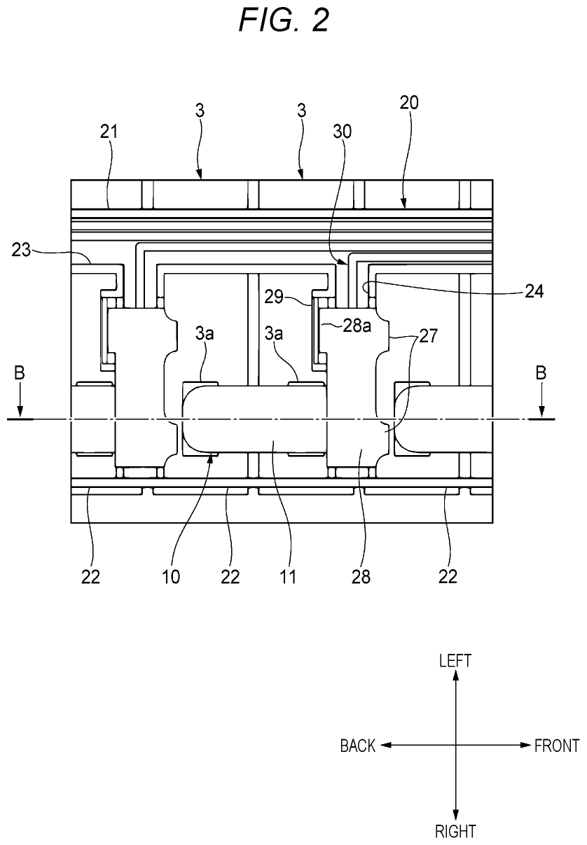

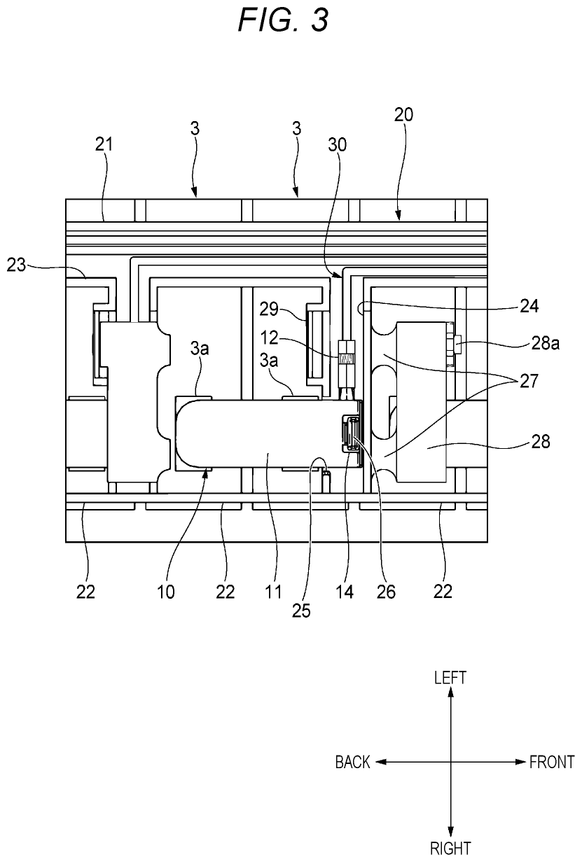

Both left and right end portions of an upper face of the battery cell 3 are provided with a pair of electrodes 3a in a manner of protruding upward (see FIGS. 2 and 3). One of the pair of electrodes 3a is a positive electrode, and the other is a negative electrode. In the assembled battery 2, the plurality of battery cells 3 are stacked in the front-rear direction in a manner that positions in the left-right direction of the positive electrode and the negative electrode of the battery cells 3 adjacent in the front-rear direction are opposite to each other. Accordingly, a plurality of electrodes 3a are arranged in a row in a manner that the positive electrode and the negative electrode are alternately arranged in the front-rear direction in each of left and right end portions of the upper face of the assembled battery 2. The electrode 3a (one of the positive electrode and the negative electrode) of the battery cell 3 positioned at a front end of the assembled battery 2 and the electrode 3a (the other of the positive electrode and the negative electrode) of the battery cell 3 positioned at a rear end of the assembled battery 2 are each connected with a total electrode busbar 40.

The pair of left and right busbar modules 4 have the same configuration except that an arrangement in the front-rear direction and an arrangement in the left-right direction are opposite to each other. Hereinafter, only the right busbar module 4 will be described in detail, and a detailed description of the left busbar module 4 will be omitted.

As illustrated in FIG. 1, the right busbar module 4 includes a plurality of detection terminals 10, a plurality of voltage detection lines 30 respectively connected to the plurality of detection terminals 10, and a resin case 20 holding the plurality of detection terminals 10 and accommodating the plurality of voltage detection lines 30.

Hereinafter, first, the resin case 20 will be described. As illustrated in FIGS. 1 and 2, the resin case 20 is a resin molded body and integrally includes a main body portion 21 linearly extending in the front-rear direction and a plurality of terminal holding portions 22 arranged in a row in the front-rear direction on a right side of the main body portion 21. Each terminal holding portion 22 has a rectangular frame shape. The terminal holding portions 22 adjacent to each other in the front-rear direction share a rear edge portion extending in the left-right direction of the front terminal holding portion 22 and a front edge portion extending in the left-right direction of the rear terminal holding portion 22. In a state in which the resin case 20 is attached to the upper face of the assembled battery 2, the terminal holding portions 22 are arranged in a manner of surrounding the “corresponding pair of electrodes 3a” adjacent to each other in the front-rear direction as illustrated in FIG. 2.

As illustrated in FIGS. 2 and 3, trunk line accommodation grooves 23 each recessed downward and extending in the front-rear direction are formed in an upper face of the main body portion 21. Branch line accommodation grooves 24 each recessed downward and extending rightward from the trunk line accommodation groove 23 are formed on an upper face of a front edge portion which extends in the left-right direction of each terminal holding portion 22. The voltage detection line 30 connected to the detection terminal 10 is accommodated and wired in the trunk line accommodation groove 23 and the branch line accommodation groove 24.

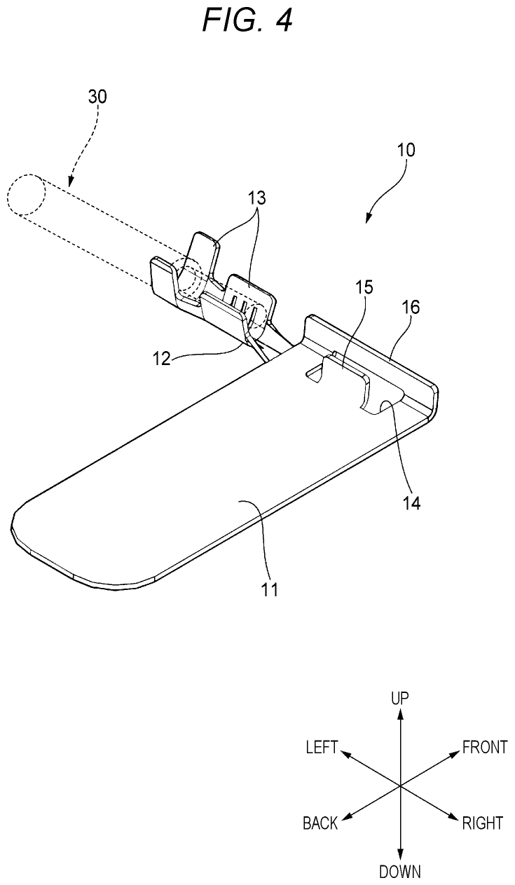

As illustrated in FIG. 3, a cutout portion 25 recessed downward is formed in a portion of a rear side wall of a pair of front and rear side walls that extend in the left-right direction and define the branch line accommodation groove 24. A busbar 11 (see FIG. 4) to be described later of the detection terminal 10 is inserted into the cutout portion 25. A columnar boss portion 26 protruding upward is formed at a position in the left-right direction corresponding to the cutout portion 25 on a bottom face of the branch line accommodation groove 24. The boss portion 26 is inserted into a through hole 14 (see FIG. 4) to be described later of the busbar 11.

A cover 28 is integrally provided on a front side wall defining the branch line accommodation groove 24 via a pair of hinges 27. The cover 28 has a rectangular flat plate shape that is long in the left-right direction. Due to a function of the hinges 27, the cover 28 is supported by the terminal holding portion 22 in a manner of being rotatable between a closed position (see FIG. 2) at which an upper end opening of the branch line accommodation groove 24 is closed and an opening position (see FIG. 3) at which the upper end opening of the branch line accommodation groove 24 is opened.

As illustrated in FIG. 3, a locking piece 28a protruding upward at the opening position is integrally provided at a left end portion of an edge portion that extends in the left-right direction and is positioned on a front side at the opening position of the cover 28. Corresponding to the locking piece 28a, a locking hole 29 is integrally formed at a position on a left side with respect to the cutout portion 25 in a rear side wall defining the branch line accommodation groove 24. When the cover 28 is closed, the locking piece 28a is inserted into the locking hole 29 and locked, whereby the cover 28 is maintained at the closed position. Effects due to the provision of the cover 28 will be described later. The resin case 20 is described above.

Next, the detection terminal 10 will be described. The metal detection terminal 10 is formed by punching and bending one metal plate. As illustrated in FIG. 4, the detection terminal includes the busbar 11 having a substantially rectangular flat plate shape that is long in the front-rear direction, and a connection portion 12 extending leftward from a front end portion of a left side edge of the busbar 11. The connection portion 12 is provided with a caulking piece 13 for connecting one end portion of the voltage detection line 30. By caulking and fixing one end portion of the voltage detection line 30 by the caulking piece 13, the end one portion of the voltage detection line 30 is connected and fixed to the connection portion 12.

The through hole 14 penetrating in the up-down direction (a plate thickness direction) is formed in the vicinity of a front end portion of the busbar 11. The through hole 14 has a substantially rectangular shape that is long in the left-right direction. The busbar 11 is provided with a cut and raised piece 15 that extends from a rear side edge extending in the left-right direction of the through hole 14 and is curved upward. The cut and raised piece 15 is formed by punching “an area excluding an area occupied by a plate-shaped portion corresponding to the cut and raised piece 15 before being cut and raised from an opening area of the through hole 14”, and bending a base portion extending in the left-right direction of the plate-shaped portion upward. Effects due to the provision of the cut and raised piece 15 will be described later.

The busbar 11 is further provided with a curved edge portion 16 that is curved upward and extends in the left-right direction at a position in the front-rear direction corresponding to a front side edge extending in the left-right direction of the through hole 14. The curved edge portion 16 is formed by bending a pair of portions extending outward in the left-right direction from both ends in the left-right direction of the front side edge of the through hole 14 in the busbar 11 upward. By providing the curved edge portion 16, bending rigidity or the like of the busbar 11 that may be lowered due to the through hole 14 can be compensated by the curved edge portion 16 provided on the busbar 11. An interval in the front-rear direction between the cut and raised piece 15 and the curved edge portion 16 is slightly larger than a width of the boss portion 26 of the resin case 20 in the front-rear direction. The detection terminal 10 is described above.

Next, a manufacturing procedure of the right busbar module 4 will be described. First, each detection terminal 10 in which one end portion of the voltage detection line 30 is connected to the connection portion 12 is assembled to the corresponding terminal holding portion 22 in the resin case 20. Specifically, as illustrated in FIG. 3, in a state in which the cover 28 is at the opening position, the boss portion 26 is inserted into the through hole 14 of the detection terminal 10 in a manner that the connection portion 12 of the detection terminal 10 is accommodated in the branch line accommodation groove 24 and the busbar 11 of the detection terminal 10 is inserted into the cutout portion 25.

When the boss portion 26 is inserted into the through hole 14 of the detection terminal 10, the curved edge portion 16 and the cut and raised piece 15 positioned before and after the boss portion 26 function as guides for guiding the boss portion 26 upward while being in surface contact with a side face of the boss portion 26. Due to this guiding function, it is easier to insert the boss portion 26 into the through hole 14 of the detection terminal 10, and damage or the like of the boss portion 26 due to contact of the boss portion 26 with a hole edge of the through hole 14 can be prevented.

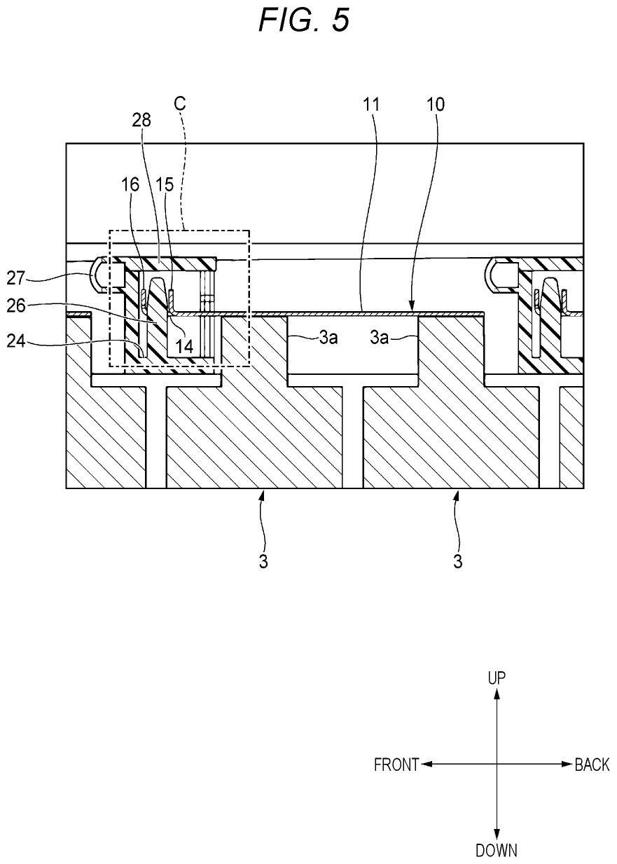

Next, as illustrated in FIG. 2, the cover 28 is closed. When the cover 28 is closed, the locking piece 28a of the cover 28 is inserted into the locking hole 29 and locked, whereby the cover 28 is maintained at the closed position. In a state in which the cover 28 is closed, the boss portion 26, the vicinity portion of a rear end including the through hole 14 in the busbar 11 of the detection terminal 10, and the connection portion 12 of the detection terminal 10 are covered with the cover 28 (see also FIG. 5).

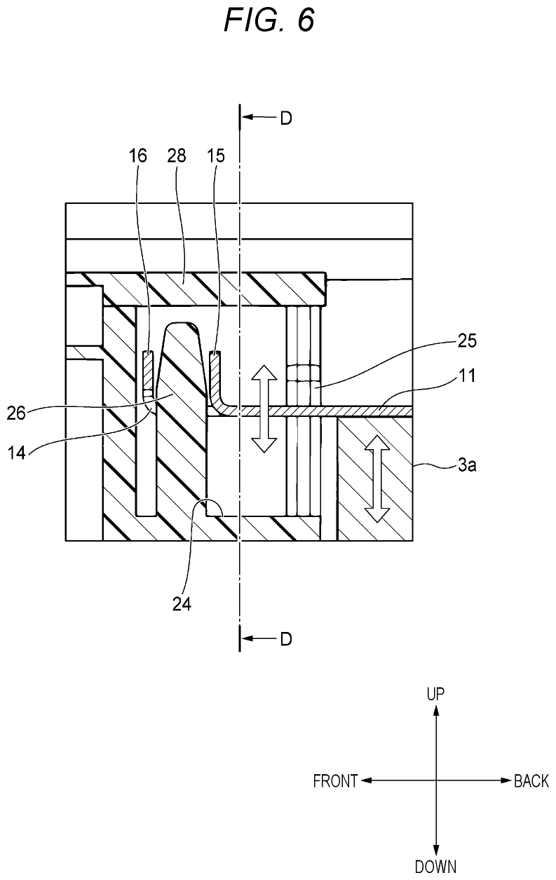

In this way, by closing the cover 28, the assembling of the detection terminal 10 to the resin case 20 is completed. In the assembled state of the detection terminal 10 to the resin case 20, due to the interval in the front-rear direction between the cut and raised piece 15 and the curved edge portion 16 being slightly larger than the width of the boss portion 26 in the front-rear direction, as indicated by a white arrow in FIG. 6, the through hole 14 (accordingly, the detection terminal 10) may move in the up-down direction with respect to the boss portion 26. However, an upward movement range of the detection terminal 10 with respect to the boss portion 26 is restricted by a lower face (a flat face) of the cover 28 as illustrated in FIGS. 5 to 7.

Accordingly, the detection terminal 10 is held by the resin case 20 in a manner of being displaceable in the up-down direction within a range restricted by the lower face (the flat face) of the cover 28 with respect to the boss portion 26 (accordingly, the terminal holding portion 22). As described above, when the detection terminal 10 is held by the resin case 20, the boss portion 26 may be inserted into the through hole 14 of the detection terminal 10. Therefore, operability of a holding operation is not impaired as in the locking claw in the related example described above.

When the assembling of the detection terminal 10 to the resin case 20 is completed, next, as illustrated in FIG. 2, the voltage detection line 30 extending leftward from the connection portion 12 of the detection terminal 10 is accommodated and wired in the trunk line accommodation groove 23 and the branch line accommodation groove 24 in a manner that the voltage detection line 30 extends leftward in the branch line accommodation groove 24, and extends forward in the trunk line accommodation groove 23 after reaching the trunk line accommodation groove 23. When the assembling of all of the plurality of detection terminals to the resin case 20 is completed by repeating the above procedure for each detection terminal 10 and wiring of all of the plurality of voltage detection lines 30 extending from the plurality of detection terminals 10 is completed, the manufacturing of the right busbar module 4 is completed (see FIG. 1).

Next, attachment of the pair of left and right busbar modules 4 to the assembled battery 2 will be described. First, as illustrated in FIG. 1, the resin cases 20 of the pair of manufactured left and right busbar modules 4 are attached to the upper face of the assembled battery 2. Accordingly, as illustrated in FIGS. 1, 2, and 5, the busbar 11 of the detection terminal held by each terminal holding portion 22 is placed on upper faces of the “pair of corresponding electrodes 3a” adjacent to each other in the front-rear direction (in particular, see FIG. 5).

Here, due to a manufacturing tolerance of the battery cell 3 and an assembly tolerance generated when the plurality of battery cells 3 are stacked, the position in the up-down direction of the electrode 3a of the battery cell 3 may vary. The variation in the position of the electrode 3a in the up-down direction due to such manufacturing tolerance and assembly tolerance can be absorbed by the detection terminal 10 moving in the up-down direction with respect to the boss portion 26 (accordingly, the terminal holding portion 22).

Next, the busbar 11 of each detection terminal 10 is connected and fixed to the “corresponding pair of electrodes 3a” by welding or the like. Accordingly, the plurality of battery cells 3 constituting the assembled battery 2 are electrically connected in series via the plurality of detection terminals 10 (the busbars 11). Further, the voltage detection line 30 connected to each detection terminal 10 is conductively connected to the “corresponding pair of electrodes 3a” connected to the detection terminal 10.

Next, the other end portions of the plurality of voltage detection lines 30 connected to the plurality of detection terminals 10 are connected to a voltage detection device (not illustrated). Accordingly, the voltage detection device can detect potentials of the “corresponding pair of electrodes 3a” conductively connected to the voltage detection lines 30. As described above, attachment of the pair of left and right busbar modules 4 to the assembled battery 2 is completed, and the battery module 1 illustrated in FIG. 1 is in a usable state.

During the use of the battery module 1, each of the battery cells 3 constituting the assembled battery 2 expands and contracts due to an operation heat associated with charging and discharging, a temperature of an external environment, and the like. As the expansion and contraction occur, the variation may occur in the position in the up-down direction of the electrode 3a of the battery cell 3. The variation in the position of the electrode 3a in the up-down direction due to the expansion and contraction of the battery cell 3 can be absorbed by the detection terminal 10 moving in the up-down direction with respect to the boss portion 26 (accordingly, the terminal holding portion 22).

As described above, according to the busbar module 4 (the terminal holding structure) according to the present embodiment, the detection terminal 10 is held by the resin case 20 in a state in which the boss portion 26 of the resin case 20 is inserted into the through hole 14 of the detection terminal 10. Further, the movement range of the detection terminal 10 in the up-down direction is restricted by the lower face (the flat face) of the cover 28. Accordingly, it is possible to displace the position of the detection terminal 10 in an attaching direction (the up-down direction) to the assembled battery 2 along the boss portion 26 within the range restricted by the cover 28. Accordingly, the variation in the position in the up-down direction of the electrode 3a of the battery cell 3 constituting the assembled battery 2 can be absorbed by the movement of the detection terminal 10. By appropriately setting the range restricted by the cover 28, it is possible to cope with the magnitude of the variation in the position in the up-down direction of the electrode 3a of the battery cell 3. Further, when the detection terminal 10 is held by the resin case 20, the boss portion 26 may be inserted into the through hole 14 of the detection terminal 10, and thus the operability of the holding operation is not impaired as in the locking claw in the related example described above. Therefore, according to the busbar module 4 according to the present embodiment, it is possible to achieve both appropriately holding of the detection terminal 10 attached to the battery cell 3 to the resin case 20 and absorbing the variation in the shape and the position of the battery cell 3.

Further, the cover 28 provided in the resin case 20 serves as a “restricting member” of the present invention. Accordingly, the movement of the detection terminal 10 can be restricted by closing the cover 28 that covers the detection terminal 10 in the operation of holding the detection terminal 10 in the resin case 20. The detection terminal 10 can be easily held in comparison with a case in which a separate restricting member independent of the resin case 20 is attached to the resin case 20.

Further, when the boss portion 26 of the resin case 20 is inserted into the through hole 14 of the detection terminal 10, the boss portion 26 can be inserted along the cut and raised piece 15 that extends from the hole edge of the through hole 14 of the detection terminal 10 and is curved upward. That is, the cut and raised piece 15 serves to guide the boss portion 26. Accordingly, it is easier to insert the boss portion 26 of the resin case 20 into the through hole 14 of the detection terminal 10, and the damage or the like of the boss portion 26 due to contact of the boss portion 26 with the hole edge of the through hole 14 can be prevented.

Further, the curved edge portion 16 curved upward is provided on a peripheral edge portion of the busbar 11 including the through hole 14. Accordingly, the bending rigidity or the like of the busbar 11 that may be lowered due to the through hole 14 can be compensated by the curved edge portion 16 provided on the busbar 11. Further, an outer shape of the detection terminal 10 is reduced, and thus an accommodation space of the detection terminal 10 in the resin case 20 can be reduced.

The present invention is not limited to the embodiment described above, and various modifications can be adopted within the scope of the present invention. For example, the present invention is not limited to the embodiment described above, and modifications, improvements, and the like can be made as appropriate. In addition, the material, shape, size, number, arrangement position, and the like of components in the embodiment described above are freely selected and are not limited as long as the present invention can be achieved.

<First Modification>

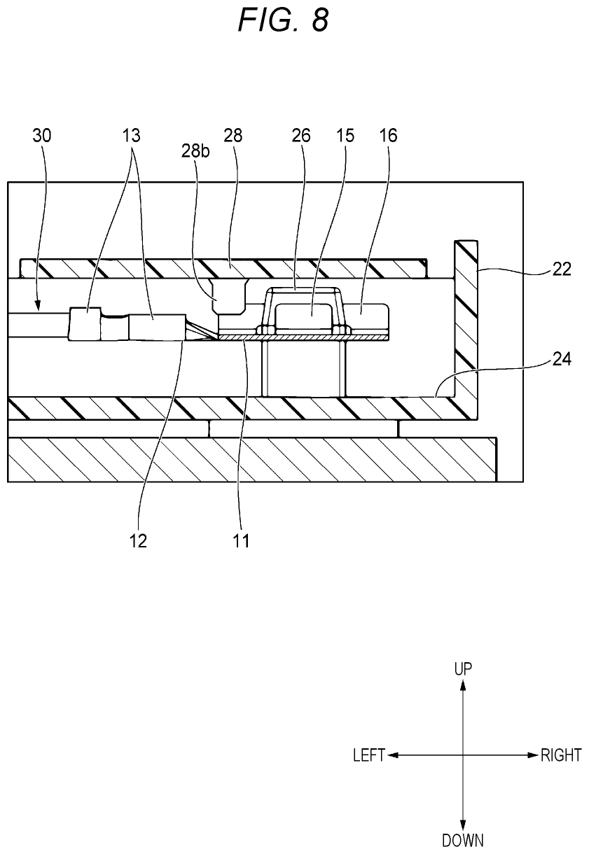

In the above embodiment, as illustrated in FIGS. 5 to 7, the cover 28 (more specifically, the lower face (the flat face) of the cover 28) functions as the “restricting member” that restricts the upward movement range of the detection terminal 10 with respect to the boss portion 26. With respect to this, as in a first modification illustrated in FIG. 8, a protruding portion 28b protruding downward (at the closed position of the cover 28) may be provided on the lower face of the cover 28 (at the closed position), and the protruding portion 28b may function as a “restricting member” that restricts the upward movement range of the detection terminal 10 with respect to the boss portion 26. In this case, by appropriately designing a protruding amount of the protruding portion 28b in consideration of a range in which the upward movement of the detection terminal 10 is restricted, it is possible to implement a holding structure corresponding to various variations of the battery cell 3 without an excessive complicated structure.

<Second Modification>

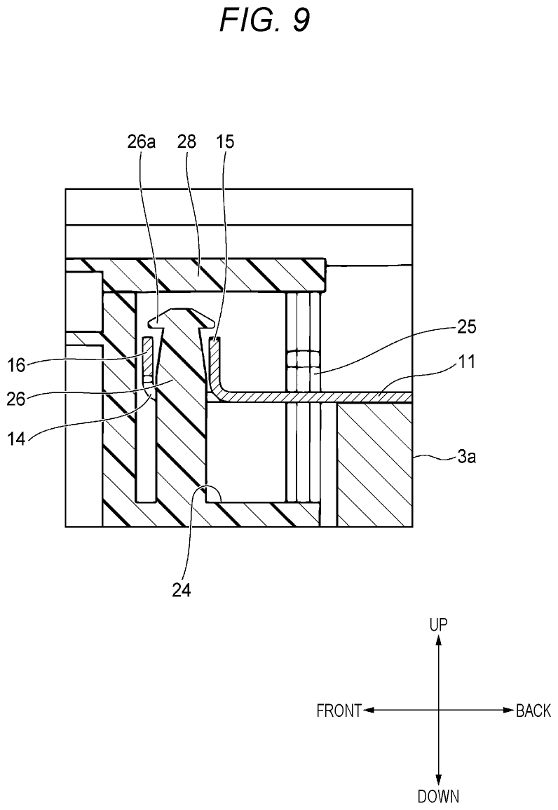

Further, as in a second modification illustrated in FIG. 9, a flange portion 26a protruding in a radial direction of the boss portion 26 may be provided at an upper end portion of the boss portion 26, and the flange portion 26a may function as a “restricting member” that restricts the upward movement range of the detection terminal 10 with respect to the boss portion 26. It is preferable that an upper face of the flange portion 26a is implemented by an inclined face (for example, a conical face) inclined in a direction in which the flange portion 26a moves downward toward the outer side in the radial direction, and a lower face of the flange portion 26a is implemented by a flat face orthogonal to an up-down direction. Accordingly, it is easy to insert the boss portion 26 into the through hole 14 of the detection terminal 10, and difficult to remove the boss portion 26 from the through hole 14.

<Third Modification>

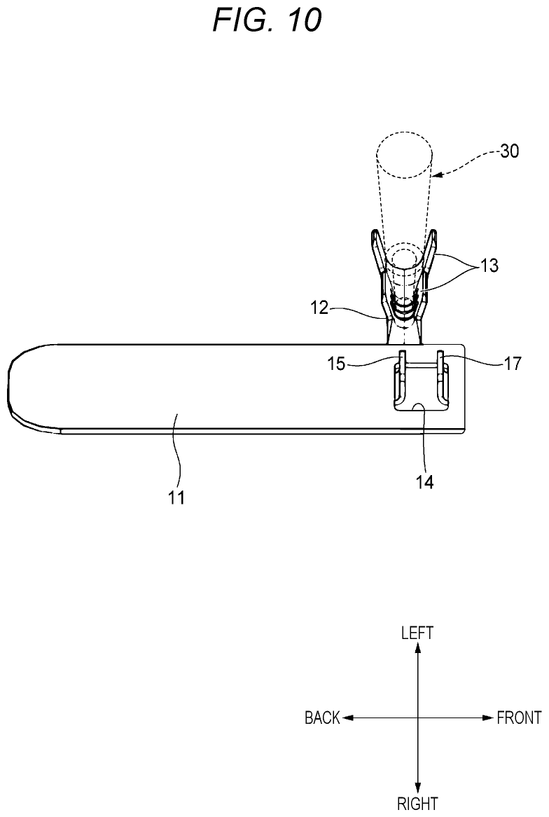

Further, in the above embodiment, the cut and raised piece 15 is provided on the rear side edge of the through hole 14 of the detection terminal 10, and the curved edge portion 16 is provided on the front side edge of the through hole 14 (see FIG. 4). With respect to this, as in a third modification illustrated in FIG. 10, the cut and raised piece 15 may be provided on a rear side edge of the through hole 14 of the detection terminal 10 as in the above embodiment, and a cut and raised piece 17 extending from a front side edge of the through hole 14 and curved upward may be provided on the front side edge of the through hole 14 instead of the curved edge portion 16. In this case, the cut and raised pieces 15 and 17 are formed by punching “an area excluding areas occupied by plate-shaped portions corresponding to the cut and raised pieces 15 and 17 before being cut and raised from an opening area of the through hole 14”, and bending base portions each extending in a left-right direction of the plate-shaped portions upward.

In the example illustrated in FIG. 10, when the boss portion 26 is inserted into the through hole 14 of the detection terminal 10, the cut and raised pieces 17 and 15 positioned before and after the boss portion 26 function as guides for guiding the boss portion 26 upward while being in surface contact with the boss portion 26. Due to this guiding function, it is easier to insert the boss portion 26 into the through hole 14 of the detection terminal 10, and damage or the like of the boss portion 26 due to contact of the boss portion 26 with a hole edge of the through hole 14 can be prevented.

<Other Modifications>

Further, in the above embodiment, in the battery cell 3 constituting the battery module 1, the electrodes 3a of both the positive electrode and the negative electrode are arranged on the side face on one side (the upper side). With respect to this, the battery cell 3 may be implemented in a manner that one of the positive electrode and the negative electrode is arranged on the side face on the one side (for example, the upper side) of the battery cell 3, and the other of the positive electrode and the negative electrode is arranged on the side face on the other side (for example, the lower side) of the battery cell 3. In addition, the battery cell 3 may be implemented in a manner of sandwiching a battery component with a conductive plate material constituting the electrode 3a instead of the above protruding electrode 3a.

Further, in the above embodiment, the detection terminal 10 is connected to one positive electrode and one negative electrode of the battery cell 3. With respect to this, the detection terminal 10 may be implemented in a manner of being connected to a plurality of positive electrodes and a plurality of negative electrodes of the battery cell 3.

Further, in the above embodiment, the holding structure for holding the detection terminal 10 in the resin case 20 is applied to the busbar module 4. With respect to this, the holding structure may be applied when a terminal such as the detection terminal 10 is held in a case such as the resin case 20 when the terminal is electrically connected to a connection target (for example, an input/output terminal of various electrical components, a busbar for power supply, an exterior housing of various electrical components, or a frame such as a vehicle on which various electrical components are mounted) different from the electrode 3a of the battery cell 3.

Here, in the embodiment of the present invention described above, a terminal holding structure includes:
a terminal (10) having a through hole (14) penetrating in an attaching direction to an object (3) to be conductively connected;
a case (20) including an insertion portion (26) to be inserted into the through hole (14) and configured to hold the terminal (10); and
a restricting member (28, 28b, 26a) configured to restrict movement of the terminal (10) in the attaching direction.

According to the holding structure having the above configuration, the terminal is held in the case in a state in which the insertion portion (for example, the columnar boss) of the case is inserted into the through hole of the terminal. Further, the movement of the terminal in the attaching direction to the object to be conductively connected (for example, an electrode of a battery) is restricted by the restricting member. Accordingly, a position of the terminal in the attaching direction to the object can be displaced along the insertion portion within the movable range restricted by the restricting member. Accordingly, the variation in the shape and the position of the object can be absorbed by the movement of the terminal in the attaching direction. By appropriately setting the movable range of the terminal by the restricting member, it is possible to cope with the magnitude of the variation of the object. Further, when the terminal is held in the case, the insertion portion may be inserted into the through hole of the terminal, and thus even if the movable range of the terminal is increased, the operability of the holding operation is not impaired as in the locking claw in the related example described above. Therefore, the holding structure having this configuration can achieve both appropriately holding the terminal attached to the object, which is to be conductively connected, to the case and absorbing the variation in the shape and the position of the object.

Further, the case (20) may include,
as the restricting member, a cover (28) configured to cover at least a part of the terminal (10).

According to the holding structure having the above configuration, the cover provided in the case serves as the restricting member. Accordingly, the movement of the terminal can be restricted by closing the cover for covering the terminal in the operation of holding the terminal in the case. The terminal can be easily held in comparison with a case in which a separate restricting member independent of the case is attached to the case.

Further, the cover (28) may have
a shape in which at least a part (28b) of the cover (28) protrudes toward the terminal (10).

According to the holding structure having the above configuration, the cover has a shape in which at least a part of the cover protrudes toward the terminal. For example, the cover includes a protruding portion protruding from the cover toward the terminal. Accordingly, by appropriately designing a protruding amount of the cover in consideration of a range in which the movement of the terminal is restricted, it is possible to implement a holding structure corresponding to various variations of the object without an excessive complicated structure.

Further, the case (20) may include,
as the restricting member, a protruding portion (26a) protruding from the insertion portion (26).

According to the holding structure having the above configuration, the protruding portion protruding from the insertion portion of the case serves as the restricting member. For example, the insertion portion includes a protruding (a so-called barb) having a shape with which insertion of the insertion portion into the through hole of the terminal is easy and removal of the insertion portion is difficult. Accordingly, the movement of the terminal can also be restricted by inserting the insertion portion of the case into the through hole of the terminal. The terminal can be easily held in comparison with a case in which a separate restricting member independent of the case is attached to the case.

Further, the terminal (10) may include
an extending portion (15, 17) extending from a hole edge of the through hole (14) and curved along the attaching direction.

According to the holding structure having the above configuration, when the insertion portion of the case is inserted into the through hole of the terminal, the insertion portion can be inserted along the extending portion extending from the hole edge of the through hole of the terminal and curved along the attaching direction. That is, the extending portion guides the insertion portion. Accordingly, it is easier to insert the insertion portion of the case into the through hole of the terminal, and damage or the like of the insertion portion due to contact of the insertion portion with the hole edge of the through hole can be prevented.

Further, the terminal (10) may include
a plate-shaped portion (11) having the through hole (14), and a curved edge portion (16) formed by curving at least a part of a peripheral edge portion of the plate-shaped portion (11) along the attaching direction.

According to the holding structure having the above configuration, at least a part of the peripheral edge portion of the plate-shaped portion having the through hole is provided with the curved edge portion curved along the attaching direction. Accordingly, the bending rigidity or the like of the plate-shaped portion that may be lowered due to the through hole can be compensated by the curved edge portion provided on the plate-shaped portion. Further, the outer shape of the terminal is reduced by bending the peripheral edge portion of the plate-shaped portion, and thus the accommodation space of the terminal into the case can be reduced.

In the embodiment of the present invention described above, a busbar module (4) includes:
a terminal (10) including a busbar (11) to be conductively connected to a battery (3), and a through hole (14) penetrating in an attaching direction to the battery (3);
a case (20) including an insertion portion (26) to be inserted into the through hole (14) and configured to hold the terminal (10) in a manner that the busbar (11) is arranged at a position corresponding to the battery (3); and
a restricting member (28, 28b, 26a) configured to restrict movement of the terminal (10) in the attaching direction.

According to the busbar module having the above configuration, the terminal is held in the case in a state in which the insertion portion (for example, the columnar boss) of the case is inserted into the through hole of the terminal. Further, the movement of the terminal in the attaching direction to the battery to be conductively connected is restricted by the restricting member. Accordingly, a position of the terminal in the attaching direction to the battery can be displaced along the insertion portion within the movable range restricted by the restricting member. Accordingly, the variation in the shape and the position of the battery can be absorbed by the movement of the terminal in the attaching direction. By appropriately setting the movable range of the terminal by the restricting member, it is possible to cope with the magnitude of the variation of the battery. Further, when the terminal is held in the case, the insertion portion may be inserted into the through hole of the terminal, and thus even if the movable range of the terminal is increased, the operability of the holding operation is not impaired as in the locking claw in the related example described above. Therefore, the busbar module having this configuration can achieve both appropriately holding the terminal attached to the battery, which is to be conductively connected, to the case and absorbing the variation in the shape and the position of the battery.

The present application is based on a Japanese patent application (Japanese Patent Application No. 2021-200850) filed on Dec. 10, 2021, contents of which are incorporated herein by reference.

### INDUSTRIAL APPLICABILITY

The terminal holding structure and the busbar module according to the present invention can achieve both appropriately holding the terminal attached to the object, which is to be conductively connected, to the case and absorbing the variation in the shape and the position of the object. The present invention having this effect can be used for, for example, a busbar module intended to supply power to various electrical components from an assembled battery in which a plurality of battery cells are stacked, and holding a terminal in the busbar module.

### REFERENCE SIGNS LIST

3: battery cell (object, battery)
4: busbar module
10: detection terminal
11: busbar (plate-shaped portion)
14: through hole
15: cut and raised piece (extending portion)
16: curved edge portion
17: cut and raised piece (extending portion)
20: resin case
26: boss portion (insertion portion)
26a: flange portion (protruding portion, restricting member)
28: cover (restricting member)
28b: protruding portion (a part of cover, restricting member)

What is claimed is:

1. A terminal holding structure comprising:
a terminal having a through hole penetrating in an attaching direction to an object to be conductively connected;
a case including an insertion portion to be inserted into the through hole and configured to hold the terminal; and
a restricting member configured to restrict movement of the terminal in the attaching direction, wherein
the terminal includes an extending portion extending from a hole edge of the through hole and curved along the attaching direction.

2. The terminal holding structure according to claim 1, wherein
the case includes, as the restricting member, a cover configured to cover at least a part of the terminal.

3. The terminal holding structure according to claim 2, wherein
the cover has a shape in which at least a part of the cover protrudes toward the terminal.

4. The terminal holding structure according to claim 1, wherein
the case includes, as the restricting member, a protruding portion protruding from the insertion portion.

5. The terminal holding structure according to claim 1, wherein
the terminal includes a plate-shaped portion having the through hole, and a curved edge portion formed by curving at least a part of a peripheral edge portion of the plate-shaped portion along the attaching direction.

6. A busbar module, comprising:
a terminal including a busbar to be conductively connected to a battery, and a through hole penetrating in an attaching direction to the battery;
a case including an insertion portion to be inserted into the through hole and configured to hold the terminal in a manner that the busbar is arranged at a position corresponding to the battery; and
a restricting member configured to restrict movement of the terminal in the attaching direction, wherein
the terminal includes an extending portion extending from a hole edge of the through hole and curved along the attaching direction.

7. The busbar module according to claim 6, wherein
the terminal includes a plate-shaped portion having the through hole, and a curved edge portion formed by curving at least a part of a peripheral edge portion of the plate-shaped portion along the attaching direction.
